(19) United States
(12) Patent Application Publication
(10) Pub. No.: US 2023/0237590 A1
(43) Pub. Date: Jul. 27, 2023

(54) OPTIMIZING MENTORSHIP MATCHES

(71) Applicant: International Business Machines Corporation, Armonk, NY (US)

(72) Inventors: Lior Aronovich, Thornhill (CA); Sam Ali-Mirsalari, Richmond Hill (CA); Jonathan D. Dunne, Dungarvan (IE)

(21) Appl. No.: 17/648,957

(22) Filed: Jan. 26, 2022

(51) Int. Cl. G06Q 50/00

(52) U.S. Cl. CPC G06Q 50/01

(57) ABSTRACT

Embodiments herein disclose computer-implemented methods, computer program products and computer systems including one or more processors configured for receiving user profile data corresponding to a plurality of user profiles each comprising profile attributes, determining profile attribute match scores for each of the profile attributes between each of the plurality of user profiles based on respective profile attribute pairs, and generating mentorship match data based on the profile attribute match scores, wherein the mentorship match data corresponds to a mentorship match between each pair of the plurality of user profiles.

### BACKGROUND

The present invention relates generally to the field of managing social media relationship connections, and more particularly to optimizing mentorship relationship connections.

Identifying potential mentor to mentee or mentee to mentor matches involve performing an analysis of mentors' and mentees' personal characteristics related to the goal of the match. Mentees are individuals seeking advice and mentors are individuals interested in providing advice. Successful mentorship matchmaking is important to all institutions, more especially those institutions committed to organizational growth and improving relational synergy among its members to support the same. Many variables are considered in determining which individuals should be paired with others to form a mentoring relationship. Additionally, subjective factors play a major part of the process in trying to maximize individual benefits. Some variables include job title, career interests, years of experiences, academic credentials, certifications, geographical location, language, and others.

### SUMMARY

The present invention is described in various embodiments disclosing computer-implemented methods, computer program products, and computer systems for optimizing mentorship matches. One embodiment of the present disclosure is a computer-implemented method including one or more processors configured for receiving user profile data corresponding to a plurality of user profiles each comprising profile attributes, determining profile attribute match scores for each of the profile attributes between each of the plurality of user profiles based respective profile attribute pairs, and generating mentorship match data based on the profile attribute match scores, wherein the mentorship match data corresponds to a mentorship match between each pair of the plurality of user profiles.

### BRIEF DESCRIPTION OF THE DRAWINGS

FIG. 1 depicts a block diagram of a distributed data processing environment for optimizing mentorship matches, in accordance with an embodiment of the present invention;

FIG. 2 depicts a flowchart of a scoring system for optimizing mentorship matches, in accordance with an embodiment of the present invention;

FIG. 3 depicts a flowchart of a computer-implemented method for optimizing mentorship matches, in accordance with an embodiment of the present invention;

FIG. 4 depicts a table matrix for optimizing mentorship matches, in accordance with an embodiment of the present invention;

FIG. 5 depicts a flowchart of an optimization method for optimizing mentorship matches, in accordance with an embodiment of the present invention;

FIG. 6 depicts a flowchart of steps of a computer-implemented method for optimizing mentorship matches, in accordance with an embodiment of the present invention; and

FIG. 7 depicts a block diagram of a computing device of the distributed data processing environment of FIG. 1, in accordance with an embodiment of the present invention.

### DETAILED DESCRIPTION

Embodiments described herein recognize that matching people who are seeking advice (i.e., mentees) with people who are interested in giving advice (i.e., mentors) is a difficult task if archaic methods are used to determine a good match. Mentorship match variables include job title, career interests, years of experiences, academic credentials, certifications, geographical location, language, and others. However, many of these variables change over time and such changes should be addressed to maintain a quality and effective match. Rather, embodiments described herein provide an automated process that optimizes the benefit and effectiveness of mentorship matches for mentees, mentors, and the organizations in which they are employed or members of. This problem is relevant for any organization or framework in which establishing mentorship connections can be beneficial or may be required. For example, in academia it is required to connect research students with advisors. In industry settings, it is beneficial to connect novice professionals with more experienced professionals who can provide mentorship in various fields. Mentorship connections can also span across organizations and geographies. Some of the archaic methods of connecting mentors and mentees includes manual processes, where an interested person (i.e., mentor or mentee) performs a manual search for counterparts and tries to maximize their individual benefit.

Embodiments described herein provide technical solutions for automatically establishing mentorship matches between mentees and mentors to maximize the inured benefit to all involved, including the organization in which the individuals belong to. For example, embodiments of the present invention are configured to perform automated matching of mentors and mentees by defining a formal optimization problem for matching mentors with mentees and providing an algorithmic solution to solve the optimization problem. The computer-implemented algorithmic solution may include maximizing the collective benefit by matching based on a combination of the perspectives (e.g., mentors' perspective in combination with mentees' perspective, plus the organization's perspective). Furthermore, the computer-implemented algorithmic solution considers ongoing feedback provided by mentees (via mentee user profiles) and mentors (via mentor user profiles) about the quality and/or effectiveness of the match as input for processes of matching over time. For example, the computer-implemented method may be configured to optimize the mentee/mentor match by processing ongoing feedback on the mentorship matches over time.

The present invention is described in various embodiments disclosing computer-implemented methods, computer program products, and computer systems establishing and optimizing mentorship matches. For example, the computer-implemented method may be configured for receiving user input data corresponding to user profiles and feedback (e.g., user provided, system determined) on mentorship matches. Further, the computer-implemented method may be configured for calculating scores for potential mentorship matches in each one of a plurality of profile attributes (e.g., fields (i.e., marketplace in which mentors and mentees want to be matched), academic background, professional background).

In an embodiment, the computer-implemented method may be configured for receiving user data corresponding to a user sign up wherein the user may provide data corresponding to a user profile comprising profile attributes. Profile attributes may include data corresponding to a user indication of interest or designation as a mentor, mentee, or both a mentor and a mentee. A user profile may include profile attributes corresponding to identification and contact details (e.g., identification, name, date of birth, email, phone number), position/title (e.g., description, type, band), biography, schedule constraints/openings, overall requirements regarding assigned mentors/mentees (e.g., geographic location, spoken languages). Further, for each profile attribute (e.g., field of possible mentorship), the computer-implemented method may be configured to receive data corresponding to a level of interest in the field, level of interest to obtain mentorship or to provide mentorship in the field, level of existing knowledge/expertise in the field, a number of mentees/mentors are requested to be matched in the field, and requirements (e.g., minimum/maximum level of experience in the field) regarding the mentees/mentors.

In an embodiment, user profile data may be gathered by providing a user interface as part of a computing device to a user so that the user may interact with the user interface to provide the user profile data. The user profile data may be stored in a memory on the computing device or may be transmitted via a network to a database or server corresponding to a web-based media platform (e.g., social media platform, enterprise media platform, a website). The web-based media platform executing on a server may be configured to allow users to create user profiles by receiving information about the user in particular profile attribute fields or profile data fields. For example, the web-based account may include a profile attribute field corresponding to profile information to receive personal information (e.g., name, date of birth, email address, residence information, personal media content) about the user. The personal information may distinguish a particular user from other users or to allow users to be found within the web-based platform using search features employing the personal information as search criteria.

In an embodiment, the one or more processors may be configured for determining a unique identifier based on the user profile data and additional unique identifiers based on each respective additional profile data. For example, determining the unique identifier may include configuring the one or more processors for extracting, using a natural language processing (NLP) engine, the user profile data from the one or more profile attribute fields. The unique identifier may be described as a fingerprint or an organized collection of the profile data.

In an embodiment, the one or more processors may be configured for processing, using the NLP engine, the user profile data (e.g., profile attributes, feedback data, match requirement data) and organizational objective data to output a set of corresponding feature vectors.

In an embodiment, the NLP engine component may be a rules-based model configured to process unstructured text data to identify profile attributes and related concepts. The rules-based NLP engine component may be in the form of an Unstructured Information Management Architecture (UIMA), which may be configured to analyze large volumes of unstructured information in order to learn information that is relevant to the study. For example, the NLP engine component may be an UIMA application configured to analyze large volumes of unstructured information to discover and learn knowledge relevant to the user profiles. The UIMA application may ingest plain text and identify profile attributes, such as identification and contact details, position title, description, type, band, schedule constraints, overall requirements regarding assigned mentors/mentees, geographical locations, languages, places, and/or organizations; or relations, such as works-for or located-at.

In an embodiment, for each profile attribute, the UIMA may be configured to determine a level of interest in the field, level of interest to obtain mentorship or to provide mentorship in the field, level of existing knowledge in the field, how many mentees or mentors are requested to be matched in the field, requirements (e.g., minimum, or maximum level of experience in the field) regarding the mentees or mentors matched in the field. Furthermore, organizational attributes (e.g., level of importance the organization assigns to various fields of mentorship) may also be determined with respect to mentorship.

In an embodiment, the computer-implemented method may be configured for receiving organizational data, for example, corresponding to a level of importance assigned by the organization to each of the profile attributes or to possible values of the profile attributes. Profile attributes that specify levels, such as levels of expertise, knowledge, interest, and importance may be assigned a level importance as a numerical value. For instance, the profile attribute may include a years of experience in a field, wherein the organization may assign this profile attribute a numerical value of 0.9 on a scale from 0 to 1, indicating a high level of importance.

In an embodiment, a mentor may be matched with a number of mentees for a mentorship connection in a specific field. For example, a university professor may advise a number of research students per field of expertise. Further, a mentee typically requires one mentor for each specific field in which mentorship is required. For example, a professional is assigned with one career mentor and one mentor in their field of work. However, multiple mentors may be assigned per mentee in a particular field.

In an embodiment, the computer-implemented method may be configured to accept input from the users on potential or already implemented matches. For example, for any pairing of a mentor and mentee, a user can optionally provide feedback about the match with the counterpart. The feedback can be based on anticipated value for the match if the match has not been implemented yet or based on actual value perceived by the user due to the match if the match was already implemented. The input can also specify whether the match has been already implemented or not. This feedback input may be considered as a component in calculating match scores.

In an embodiment, the computer-implemented method may be configured to output mentorship matches in the plurality of fields to maximize the collective benefit of the mentorship match.

In an embodiment, a computer-implemented method includes one or more processors configured to receive user profile data corresponding to a plurality of user profiles each comprising profile attributes. For example, the user profile data may include profile attributes corresponding to feedback data selected from a group consisting of a prior mentorship match and a potential mentorship match between a pair of the plurality of user profiles. For instance, the feedback data may include user input about a prior mentorship match the user profile was previously matched with, such as success of the match, improvements about the match, comments about the match, a rating of the match, or any other information concerning the match with a mentor or mentee, wherein the feedback data may be associated with the mentor or mentee that the prior mentorship match was with. Alternatively, the feedback data may include user input about a potential mentorship match the user profile is suggested as a potential match with, wherein the feedback data may be associated with the mentor or mentee that the potential mentorship match would be with.

In an embodiment, the computer-implemented method includes one or more processors configured to determine profile attribute match scores for each of the profile attributes between each pair of the plurality of user profiles based on respective profile attribute pairs, determine component attribute match scores based on the profile attribute match scores for each pair of the plurality of user profiles, and generate mentorship match data based on the component attribute match scores, wherein the mentorship match data corresponds to a mentorship match between each pair of the plurality of user profiles.

In an embodiment, the computer-implemented method includes one or more processors configured to determine a mentor match score for mentor user profiles having a mentor designation in the profile attributes in relation to mentee user profiles having a mentee designation in the profile attributes, and determine a mentee match score for the mentee user profiles in relation to the mentor user profiles, wherein the profile attribute match scores include the mentor match score and the mentee match score.

In an embodiment, the computer-implemented method includes one or more processors configured to receive organizational objective data comprising profile attribute weights corresponding to a desired objective between the plurality of user profiles.

In an embodiment, the computer-implemented method includes one or more processors configured to apply the profile attribute weights to the profile attributes to generate weighted profile attributes.

In an embodiment, the profile attribute match scores may be determined based on the weighted profile attributes, wherein the mentorship match data may correspond to a weighted optimized mentorship match between each pair of the plurality of user profiles comprising the weighted profile attributes.

In an embodiment, the profile attributes may include match requirement data corresponding to a profile attribute necessary to achieve a match between the plurality of user profiles.

In an embodiment, the computer-implemented method may include one or more processors configured to assign a do not match score to the profile attribute match score of each pair of the plurality of user profiles comprising the match requirement data that fails to satisfy a similarity threshold.

In an embodiment, the computer-implemented method may include one or more processors configured to process, by a machine learning model, the user profile data to generate model output data corresponding to feature vectors representing the profile attributes.

In an embodiment, the computer-implemented method may include one or more processors configured to generate a relationship pairwise matching model based on the feature vectors and generate the relationship pairwise matching model based on the feature vectors and the feedback data, wherein the mentorship match data corresponds to a first optimized mentorship match between each pair of the plurality of user profiles comprising the feedback data.

In an embodiment, the computer-implemented method may include one or more processors configured to generate a graphical representation of the mentorship match between a pair of the plurality of user profiles having a greatest of the component attribute match scores.

The present invention will now be described in detail with reference to the Figures.

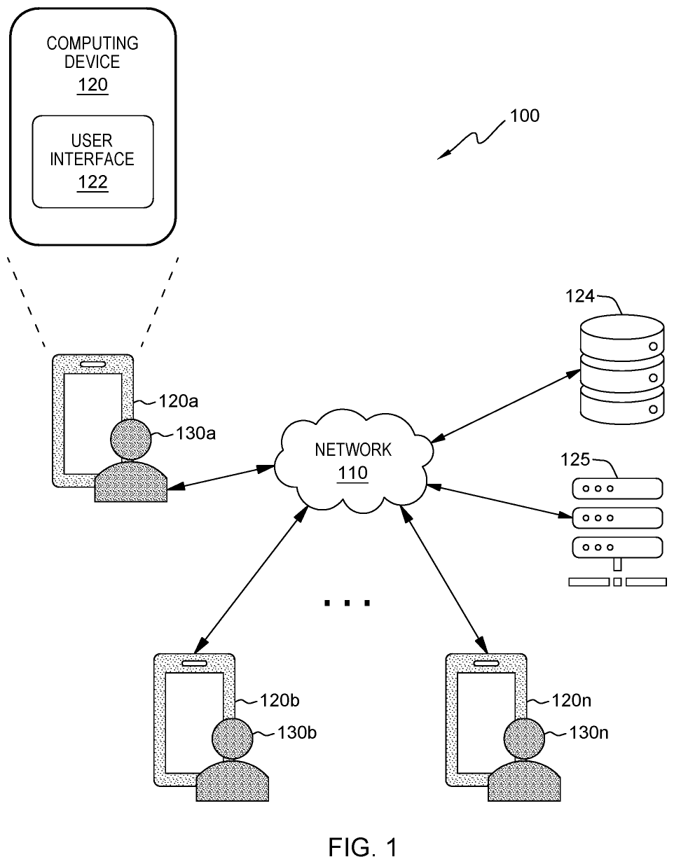

FIG. 1 depicts a block diagram of a distributed data processing environment for prioritizing and recommending social media interactions, in accordance with an embodiment of the present invention. FIG. 1 provides only an illustration of one embodiment of the present invention and does not imply any limitations with regard to the environments in which different embodiments may be implemented. In the depicted embodiment, distributed data processing environment 100 includes computing device 120a associated with a first user 130a, additional computing devices 120b . . . 120n associated with respective users 130b . . . 130n, server 125, and database 124, interconnected over network 110. Network 110 operates as a computing network that can be, for example, a local area network (LAN), a wide area network (WAN), or a combination of the two, and can include wired, wireless, or fiber optic connections. In general, network 110 can be any combination of connections and protocols that will support communications between computing device 120a, additional computing devices 120b . . . 120n, server 125, and database 124. Distributed data processing environment 100 may also include additional servers, computers, or other devices not shown.

Computing device 120a and additional computing devices 120b . . . 120n operate to execute at least a part of a computer program for prioritizing and recommending social media interactions. In an embodiment, computing device 120a and additional computing devices 120b . . . 120n may be configured to send and/or receive data from one or more of the other computing device(s) via network 110. Computing device 120a and additional computing devices 120b . . . 120n may each include a user interface 122 configured to facilitate interaction between user 130 and computing device 120. For example, user interface 122 may include a display as a mechanism to display data to a user and may be, for example, a touch screen, light emitting diode (LED) screen, or a liquid crystal display (LCD) screen. User interface 122 may also include a keypad or text entry device configured to receive alphanumeric entries from a user. User interface 122 may also include other peripheral components to further facilitate user interaction or data entry by user associated with respective computing device 120.

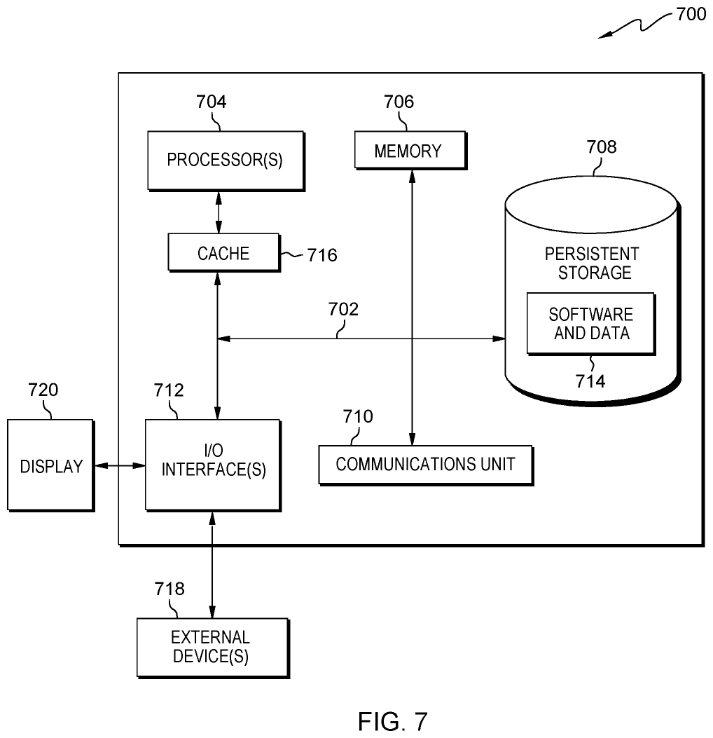

In some embodiments, computing device 120a and additional computing devices 120b . . . 120n may be a management server, a web server, or any other electronic device or computing system capable of receiving and sending data. In some embodiments, computing device 120a and additional computing devices 120b . . . 120n may be a laptop computer, tablet computer, netbook computer, personal computer (PC), a desktop computer, a smart phone, or any programmable electronic device capable of communicating with database 124, server 125 via network 110. Computing device 120a and additional computing devices 120b . . . 120n may include components as described in further detail in FIG. 7.

Computing device 120a and additional computing devices 120b . . . 120n may be configured to receive, store, and/or process user profile data received via user interface 122 of computing device 120. Computing device 120a and additional computing devices 120b . . . 120n may be configured to store the user profile data in memory or transmit the user profile to database 124 and/or server 125 via network 110 for further storage and/or processing.

Database 124 operates as a repository for data flowing to and from network 110. Examples of data include user profile data corresponding to profile attributes, mentorship match feedback data, organizational objectives data, match requirement data, and other data related to establishing a mentorship match between two user profiles. A database is an organized collection of data. Database 124 can be implemented with any type of storage device capable of storing data and configuration files that can be accessed and utilized by computing device 120a and additional computing devices 120b . . . 120n, such as a database server, a hard disk drive, or a flash memory. In an embodiment, database 124 is accessed by computing device 120a and additional computing devices 120b . . . 120n to store data corresponding to user profiles, uploading media to a media platform server, and interactions performed within the media platform. In another embodiment, database 124 may reside elsewhere within distributed network environment 100 provided database 124 has access to network 110.

Server 125 can be a standalone computing device, a management server, a web server, or any other electronic device or computing system capable of receiving, sending, and processing data and capable of communicating with computing device 120a and additional computing devices 120b . . . 120n, and/or database 124 via network 110. In other embodiments, server 125 represents a server computing system utilizing multiple computers as a server system, such as a cloud computing environment. In yet other embodiments, server 125 represents a computing system utilizing clustered computers and components (e.g., database server computers, application server computers, etc.) that act as a single pool of seamless resources when accessed within distributed data processing environment 100. Server 125 may include components as described in further detail in FIG. 7.

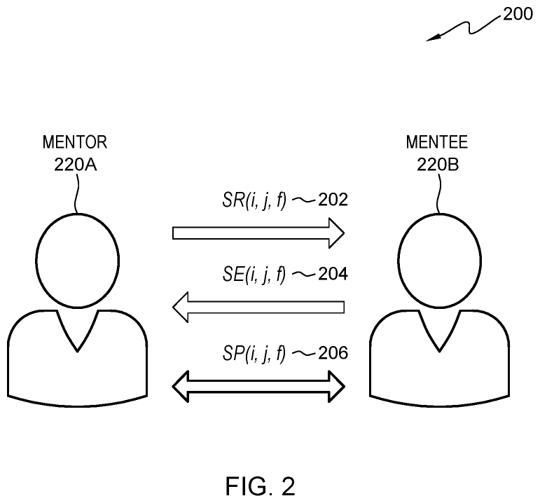

FIG. 2 depicts a flowchart of a scoring system 200 for optimizing mentorship matches, in accordance with an embodiment of the present invention.

In an embodiment, system 200 may include a plurality of user profiles (e.g., mentor 220A user profile, mentee 220B user profile) comprising profile attributes provided by or associated with respective user profiles of users. Once the user profiles are created within system 200, system may be configured to receive user profile data comprising the profile attributes. Numerical representations of the profile attributes may be used to determine mentorship match scores between mentor 220A user profile and mentee 220B user profile corresponding to the quality of the match.

In an embodiment, for each match, system 200 may be configured to calculate separate scores from individual perspectives (i.e., a score from the mentee's perspective and a score from the mentor's perspective), based on the user profiles attributes. For example, given that there are Nr mentors and Ne mentees in a specific field at a given point in time, wherein a mentor/mentee pair match score (e.g., profile attribute match score 206) may be calculated based on the profile attributes of the pair members (e.g., mentor 220A user profile, mentee 220B user profile) and specifically on the profile attributes for the specific field specified in the corresponding user profiles.

In an embodiment, system 200 may be configured to determine mentor match score 202, wherein mentor match score 202 may be calculated from the perspective of mentor 220A, wherein mentor match score 202 is the score assigned by mentor 220A to mentee 220B in this field. Mentor match score 202 may be denoted as SR(i, j, f)—that is the score assigned by mentor 220A i to mentee 220B j in field f, wherein field f may be represented as data in the profile attributes.

In an embodiment, system 200 may be configured to determine mentee match score 204, wherein mentee match score 204 may be calculated from the perspective of mentee 220B, wherein mentee match score 204 is the score assigned by mentee 220B to mentor 220A in this field. Mentee match score 204 may be denoted as SE(j, i, f)—this is the score assigned by mentee 220B j to mentor 220A i in field f. Mentor match score 202 and mentee match score 204 are scores that can be different for a given pair of mentee 220B and mentor 220A in each field. In an embodiment, the value range of each of these two types of scores (e.g., mentor match score 202 and mentee match score 204) may be 0-1, where 0 is the lowest score and 1 is the highest score.

In an embodiment, system 200 may be configured to combine mentor match score 202 (e.g., SR(i, j, f)) and mentee match score 204 (e.g., SE(j, i, f)) into unified pair score 206 (e.g., SP(i, j, f)) for a given pair of mentor 220A and mentee 220B. For example, the SR and SE scores can be combined into a unified pair score using weights, where the weights can be predetermined by the organization. The weights signify the relative importance of the two perspectives—mentor's perspective and mentee's perspective. If the perspectives are equally important, then uniform weights can be assigned.

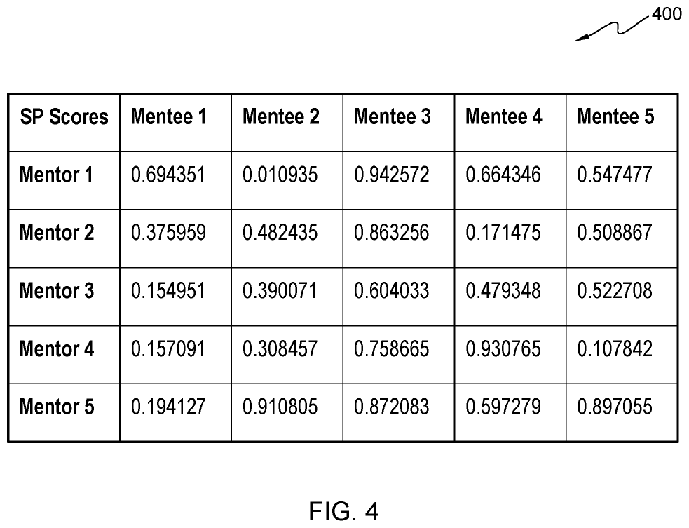

In an embodiment, system 200 may be configured to consider each field where mentees and mentors can be matched as an independent matching marketplace. In an embodiment, there are Nfr mentors and Nfe mentees in a specific field at a given point in time. For example, the pair scores (e.g., unified pair score 206 SP(i, j, f)) for each mentor and mentee pair (e.g., mentor 220A, mentee 220B) can be stored in a matrix: M_{f}[i, j]=SP(i, j, f), where M_{f} is the matrix for field f, M_{f}[i, j] is the contents of cell [i, j] in the matrix, and SP(i, j, f) is the unified pair score 206 SP(i, j, f) for mentor i and mentee j in field f. Assuming that the i index represents the rows of the matrix, then each mentor has a respective row in the matrix, and each mentee has a respective column in the matrix (e.g., table matrix 400 of FIG. 4). Further, a cell in the matrix can also contain the SR and SE of the pair, and any additional relevant information for the pair. However, in the following we also consider that a cell in the matrix contains the SP score of the pair.

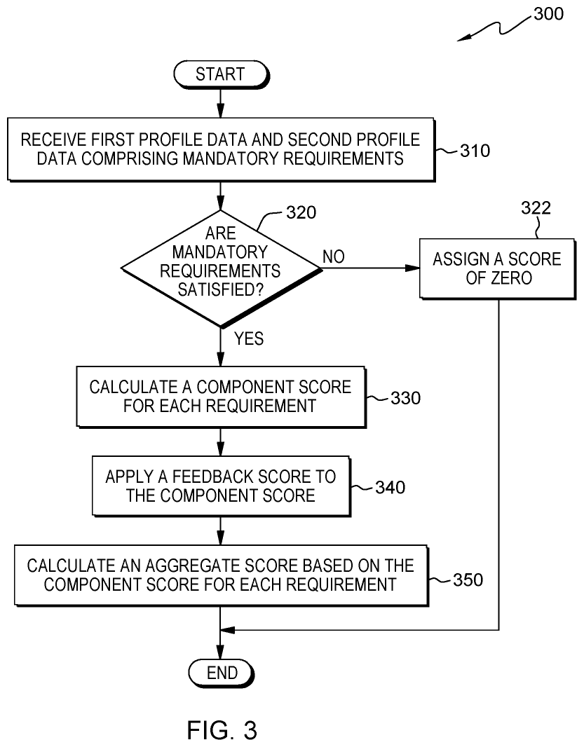

FIG. 3 depicts a flowchart of a computer-implemented method 300 for optimizing mentorship matches, in accordance with an embodiment of the present invention.

In an embodiment, for each potential match, computer-implemented method 300 may include one or more processors configured to calculate an individual perspective score for the potential match.

In an embodiment, computer-implemented method 300 may include one or more processors configured to receive 310 first profile data and second profile data comprising mandatory requirements. Further, computer-implemented method 300 may be configured to determine 320 if all the mandatory requirements from the perspective of the current pair member regarding the counterpart pair member are satisfied. If all the mandatory requirements are satisfied, then computer-implemented method 300 may include one or more processors configured to calculate 330 a component score for each requirement. Alternatively, if all the mandatory requirements are not satisfied, then computer-implemented method 300 may include one or more processors configured to assign 322 a score of zero to the perspective score for the potential matching user profiles.

In an embodiment, computer-implemented method 300 may include one or more processors configured for calculating a component score for each requirement based on the level in which the counterpart pair member satisfies the requirement of the current pair member. For example, a component score for the quality of mentorship and information that a mentor provides in a field may be based on information corresponding to ratings the mentor received from mentees during mentorship relationships in a particular field. Further, this component score may be based on information corresponding to the mentor's credentials in the field, or the mentor's involvement in publications and public or group conversations in the field. Furthermore, this component score may be integrated into the calculation of the mentee assigned score (e.g., SE(j, i, f) to the mentor in the field by adding this component score with an associated weight from the mentee's perspective.

Furthermore, in an embodiment, computer-implemented method 300 may include one or more processors configured to calculate 340 a component feedback score that the current pair member assigns to the match with the counterpart pair member. This component feedback score can be based on anticipated value provided by the current member for the potential match, or based on actual value perceived by the current member on the match if the match was already implemented. The component feedback score may be configured to optimize the unified pair score due to receiving additional information from one or more of the user profile users indicating a desire to match or not be matched with the other user.

In an embodiment, computer-implemented method 300 may include one or more processors configured for determining a component score for the effective use of mentorship training by a mentee. For example, the component score may be based on information corresponding to mentee achievements earned after and/or before engaging in the mentorship relationship with the mentor. Mentee achievements may include ratings that the mentee received from mentors or other supervisory individuals within the organization. Mentee achievements may also include the mentee's involvement in publications and public or group conversations in a field measured after and/or before engaging in the mentorship relationship with the mentor. Furthermore, the component score may be integrated into the calculation of the mentor assigned score (e.g., SR(i, j, f) to the mentee in the field by adding the component score with an associated weight from the mentor's perspective.

In an embodiment, computer-implemented method 300 may be configured to combine the individual perspective scores including the mentor match perspective score SR(i, j, f)) and the mentee match perspective score SE(j, i, f)) into a unified component pair score SP(i, j, f)) for a given pair of mentor and mentee. For example, the SR and SE scores can be combined into a unified pair score using weights, where the weights can be predetermined by the organization or determined otherwise. The weights signify the relative importance of the two perspectives—mentor's perspective and mentee's perspective. If the perspectives are equally important, then uniform weights can be assigned.

In an embodiment, the component scores may be dynamic such that they change over time based on receiving additional data from the one or more of the user profiles associated with the mentors and the mentees. Therefore, the component scores may have varying impacts on the matching calculation iterations.

Furthermore, in an embodiment, computer-implemented method 300 may include one or more processors configured to calculate 350 an aggregate score based on the component scores. For example, the aggregated score may be calculated as a weighted summation of the component scores. Further, the aggregated component score is either SR or SE for a given pair of a specific profile attribute (e.g., a specific field).

In an embodiment, the computer-implemented method may be configured for calculating each of the scores (i.e., SR, SE) for a given pair of users (i.e., mentor, mentee). For example, calculating a score from a specific perspective, either SR score from the mentor's perspective, or SE score from the mentee's perspective, may include determining if any mandatory requirements exist from the perspective of a mentorship pair of users that one of the users of the mentorship pair does not satisfy. If one user of the mentorship pair users designates a mandatory requirement that another user of the mentorship pair users does not satisfy, then the perspective score assigned by the user that designated the mandatory requirement may be assigned a value of 0, indicating a do not match score. For example, match mandatory requirements may include profile attributes corresponding to requested schedules, geographic locations, spoken languages, minimum/maximum field experience level. Thus, if all mandatory requirements are satisfied by the counterpart pair member, then the perspective score will be greater than 0 so that the mentorship match may be potentially attainable and/or proceed to further evaluations or considerations.

In an embodiment, the computer-implemented method may be configured for calculating a component score for each requirement based on the level in which the counterpart pair member satisfies the requirement of the current pair member. For example, a geographic location within a satisfactory proximity generates a higher component score for location, a match in native spoken languages generates a higher component score for language, a level of knowledge in the field that is closer to the required level of knowledge generates a higher component score for knowledge, and a level of interest in the field that is closer to the required level of interest generates a higher component score for interest.

In an embodiment, the computer-implemented method may be configured to calculate a component score based on a feedback response provided by a user (e.g., mentee, mentor) regarding the counterpart user (e.g., mentor, mentee) of the mentorship pair. The component score may be based on an anticipated value provided by the current user for the potential match or based on actual value perceived by the current user on the match if the match was already established.

In an embodiment, the computer-implemented method may be configured to aggregate the component scores into an aggregated score. For example, assuming that the value range of the component scores is 0-1, and the user may provide levels of relative importance on the different requirements. With those assumptions considered, the user may be prompted to response to questions about the mentorship match. Some questions may include, for example: “how important is the geographic aspect, language aspect, knowledge aspect, interest aspect, etc.?” Further, the levels of relative importance may be converted to weights between 0-1, which may then be summarized to 1. If the user does not provide weights, then uniform weights may be assigned, or alternatively, a pre-configured set of weights may be assigned to the corresponding profile attributes. Furthermore, if feedback is available and a component score for feedback is available as described above herein, then the relative weight of the component score for feedback may be higher than the relative weights of the other component scores. For example, if the feedback-based component score is based on feedback on a match that was already implemented, then the weight for this component score can be as high as 1. Further, if the feedback-based component score is based on anticipated value, then its weight can be lower than 1 but higher than the weight of other component scores.

In an embodiment, the computer-implemented method 300 may be configured to calculate 350 an aggregated score as a weighted summation of the component scores. For example, the aggregated score is either SR or SE for a given pair of a specific profile attribute (e.g., a specific field).

FIG. 4 depicts a table matrix 400 for optimizing mentorship matches, in accordance with an embodiment of the present invention.

In an embodiment, the computer-implemented method may be configured to calculate mentorship matches for each one of the profile attributes (e.g., fields) by generating a score matrix 400 for each profile attribute, and applying a matching algorithm on each matrix, wherein the matching algorithm may be configured to optimize a collective benefit function. In an embodiment, each field (e.g., profile attribute) may be considered or factored into the score calculation where mentees and mentors can be matched as an independent matching marketplace. For example, if there are Nfr mentors and Nfe mentees in a specific field at a given point in time, then the pair scores for each mentor and mentee pair may be stored in a matrix: M_{f}[i, j]=SP(i, j, f), where M_{f} is the matrix for field f, M_{f}[i, j] is the contents of cell [i, j] in the matrix, and SP(i, j, f) is the unified pair score for mentor i and mentee j in field f. Further, assuming that the i index represents the rows of the matrix, then each mentor has a respective row in the matrix, and each mentee has a respective column in the matrix. Even further, a cell in the matrix may also contain the SR and SE of the pair, and any additional relevant information for the pair. Nonetheless, a cell in the matrix may include the SP score of the pair for further consideration.

In an embodiment, score matrix 400 may include the set of mentors in a field as R_{f}={rᵢ} and the set of mentees in a field as E_{f}={eᵢ}, wherein each mentor is matched with a set of specific mentees. For example, the set of mentees matched for a mentor rᵢ may be described as E_{f} (rᵢ)={e_{ri,i}}, and Nfrᵢe is the size of E_{f}(rᵢ). In an embodiment, score matrix 400 may corresponding to an input to an objective function described herein. Thus, score matrix 400 may be used as input for an objective function (e.g., optimization algorithm) for optimizing a mentorship match, wherein the output from the objective function may include output data identifying sets of mentees to assign to the mentors (each mentor is assigned to a set of mentees). In other words, score matrix 400 may correspond to inputs to maximize an objective function specified by the following equation:

$$OF ( f ) = MAX \{ {\sum }_{{r}_{i} = 1}^{{N}_{fr}} {\sum }_{{e}_{{r}_{i} , j} = 1}^{{N}_{{fr}_{i} e}} SP ( {r}_{i} , {e}_{{r}_{i} , j} , f ) \} .$$

In an embodiment, score matrix 400 may be configured to identify selected mentorship matches that maximize the pair scores across all the matches, wherein the maximum value possible for this objective function, for given sets of mentors and mentees, is: Σᵣ_{ᵢ}₌₁^{N}^{_{fr}}N_{fr}_{ᵢ}_{eMax}, wherein N_{fr}_{ᵢ}_{eMax} is the maximum number of mentees that can be assigned to mentor rᵢ in this field f. This maximum possible value is an upper bound, as the number of mentees in the field may be lower than some values of N_{fr}_{ᵢ}_{eMax} and as it is assumed that mentees are assigned exclusively to mentors in the field. Therefore, the overall objective function summarizes the field level objective functions across all the fields: OF=Σ_{f}_{ᵢ}OF(fᵢ).

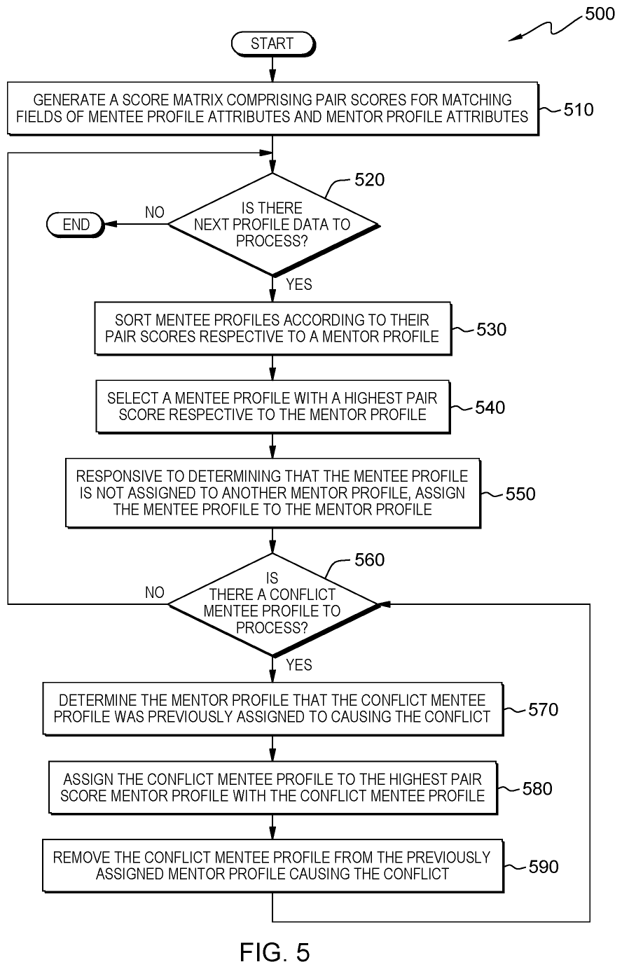

FIG. 5 depicts a flowchart of an optimization method 500 for optimizing mentorship matches, in accordance with an embodiment of the present invention.

In an embodiment, method 500 may include one or more processors configured to received user profile data as input data, wherein the user profile data may include profile attributes corresponding to an interest or an indication to be designated as a mentor, a mentee, or both a mentor and a mentee. Further, the one or more processors may be configured to generate output data corresponding to a matching of mentors and mentees based on the profile attributes represented in the user profile data.

In an embodiment, method 500 may include one or more processors configured to generate 510 a score matrix for each field of matching mentors and mentees, the score matrix comprising pair scores for matching of mentee profiles and mentor profiles in a field. For example, the one or more processors may be configured to calculate pair scores for all the mentors and mentees in a field based on their profiles' attributes. Further, the one or more processors may be configured to generate score matrices only for fields that have mentors and mentees to match, wherein the mentor and mentee matching data may be represented as a set of score matrices, where each matrix is associated with a field.

In an embodiment, method 500 may include one or more processors configured to determine 520 if there is next profile data (e.g., score matrix, field data, mentor profile attribute data) to process. For example, profile data may be represented as a score matrix. Further, in an embodiment, method 500 may further include one or more processors configured to determine if there is a next mentor profile to process.

In an embodiment, responsive to determining that there is next profile data (e.g., mentor profile data) to process, method 500 may be configured to sort 530 mentee profiles according to their pair scores respective to a mentor profile. For example, for each mentor rᵢ in the field—represented by a row i in the matrix M_{f}—method 500 may be configured to process data in matrix M_{f}, wherein MaxMatchesᵢ may be the maximal number of mentees requested by mentor rᵢ in this field. Further, method 500 may be configured to sort 530 the mentees in this field according to the pair score respective to this mentor, in descending order (from the highest score to the lowest score). In an embodiment, the one or more processors may be configured to store the ordering of the mentees for this mentor.

In an embodiment, method 500 may include one or more processors configured to select 540 a mentee profile with a highest pair score respective to the mentor profile. For example, the one or more processors may be configured to select up to MaxMatchesᵢ mentees with the highest pair scores respective to the mentor, or in other words, select the top—up to MaxMatchesᵢ—mentees from the ordering.

In an embodiment, responsive to determining that the mentee profile is not assigned to another mentor profile, and for each mentee that was selected with the highest pair scores, method 500 may include one or more processors configured to assign 550 the mentee profile to the mentor profile. Furthermore, if the mentee was previously assigned to another mentor, then the one or more processors may be configured to add this mentee to an ordered list of mentees (e.g., conflict mentee list), wherein the ordered list of mentees may be dynamically ordered in descending order of the maximum pair score per mentee. As such, the maximum pair score per mentee may be the maximum pair score for the mentee respective to the two mentors in conflict for this mentee.

In an embodiment, method 500 may include one or more processors configured to determine 560 if there is a conflict mentee profile to process. In an embodiment, if there is a conflict mentee profile to process, then the one or more processors may be configured to determine 570 the mentor profile that the conflict mentee profile was previously assigned to causing the conflict. For example, as long as the list of conflict mentees in not empty, then the one or more processors may be configured to scan the conflict mentees according to their order in the list and resolve the conflict for each conflict mentee.

In an embodiment, method 500 may include one or more processors configured to assign 580 the conflict mentee profile to the mentor profile that has the highest pair score with the conflict mentee profile. For example, considering the current mentor being processed and the mentor that this conflict mentee is already assigned to, the one or more processors may be configured to assign this conflict mentee to the mentor, of these two mentors, with whom the mentee has a higher pair score.

In an embodiment, for the other mentor, method 500 may include one or more processors configured to remove 590 the conflict mentee profile from the previously assigned mentor profile causing the conflict. For example, the one or more processors may be configured to select a mentee with the next highest score (respective to the conflict mentee) in the ordering of mentees for this mentor (namely appearing in the ordered list after the conflict mentee), wherein the selected mentee is not assigned to this mentor. However, if there is no such mentee as specified above, then no further steps may be performed for the other mentor. Furthermore, if there is such a mentee with the next highest score, and if this mentee is not already assigned to any other mentor, then the one or more processors may be configured to assign this mentee to the other mentor. Alternatively, if the mentee with the next highest score is already assigned to another mentor, then the one or more processors may be configured to add this mentee to the list of conflict mentees (i.e., the mentee is added to the list based on an ordering of the list).

In yet another embodiment, method 500 may include one or more processors configured for dynamically adding, updating, and removing mentors and mentees from mentorship matches to achieve dynamic optimization.

In an embodiment, the one or more processors may be configured to perform a full matches calculation upon any dynamic operation, or alternatively upon specific types of dynamic operations (where other types use incremental or other method of calculation).

In an embodiment, the one or more processors may be configured to perform a full matches calculation based on a trigger. The trigger can be based on time elapsed since the last calculation, and/or on a number of profile additions/updates/removals performed since the last calculation. Further, the one or more processors may be configured to provide approximate match results for user profiles which are added and updated. For example, approximate matches may be calculated using a fast local calculation for the specific user profile that was added or updated. In an embodiment, the one or more processors may be configured to perform incremental calculation methods add, update, and remove user profiles.

In an embodiment, the one or more processors may be configured to add a row representing the new mentor to the scores matrix of each field that the new mentor can provide mentorship. For example, a row is generated by calculating the pair scores for the new mentor with all the mentees in a field based on their profiles' attributes. For each one of the fields for which a score matrix was added with a row and its respective score matrix, the one or more processors may be configured to calculate a mentorship match score with optimization, as described above herein, for the new added mentor rₙ—represented by the new row n in the matrix M_{f}.

In an embodiment, method 500 may include one or more processors configured to receive input data corresponding adding potential mentors and mentees into the mentorship matching system. For example, the one or more processors may be configured for receiving input data corresponding to users directly adding, updating, or removing user profiles with respect to the mentorship matching system.

In an embodiment, method 500 may include mentorship matching system configured for accessing other sources of data (e.g., external systems) of human capital information to generate candidate user profiles and candidate mentorship matches. For example, application programming interfaces (APIs) of external systems can be used to analyze information—to determine users who may potentially be interested in receiving or providing mentorship, based on various criteria. For example, a new employee user may be interested in receiving mentorship, and senior employee users with various credentials may be interested in providing mentorship. Thus, method 500 may be configured for generating candidate user profiles from the new employee users and senior employee users information, for both candidate mentees and candidate mentors.

In an embodiment, method 500 may be configured for calculating or marking differently matches for candidate user profiles for both candidate mentees and candidate mentors. Furthermore, method 500 may be configured for generating a notification for notifying candidate users (whose profiles were generated automatically) about candidate mentorship matches that were calculated for them. Therefore, the one or more processors may be configured to grant system access to the candidate users (e.g., via user profiles associated with the users) to update and verify their profiles and to subsequently receive official mentorship matches recommendations via the notifications.

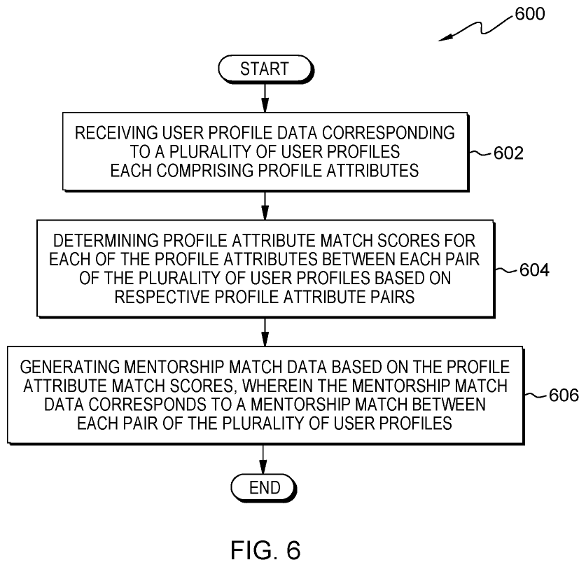

FIG. 6 depicts a flowchart of steps of a computer-implemented method 600 for optimizing mentorship matches, in accordance with an embodiment of the present invention.

In an embodiment, computer-implemented method 600 may include one or more processors configured for receiving 602 user profile data corresponding to a plurality of user profiles each comprising profile attributes.

In an embodiment, computer-implemented method 600 may include one or more processors configured for determining 604 profile attribute match scores for each of the profile attributes between each pair of the plurality of user profiles based on respective profile attribute pairs. For example, profile attribute match scores may be determined for each of the profile attributes between each pair of the plurality of user profiles based on respective profile attribute pairs. For instance, a mentee profile attribute may include an interest in an engineering field and a mentor profile may include career experience in the engineering field, wherein the profile attribute match score may be determined to exceed a similarity threshold between the mentor profile attributes and the mentee profile attributes because they both are in the engineering field in which a mentorship match would benefit. As such, profile attributes do not have to necessarily be identical to achieve a match. For example, a career field profile attribute may be compared to a career interest profile attribute to determine a match. As another example, identical profile attributes may be identical in determining a match as well. Furthermore, profile attribute match scores may be determined based on the weighted profile attributes, wherein the mentorship match data may correspond to a weighted optimized mentorship match between each pair of the plurality of user profiles comprising the weighted profile attributes.

In an embodiment, computer-implemented method 600 may include one or more processors configured for determining 606 component attribute match scores based on the profile attribute match scores for each pair of the plurality of user profiles.

In an embodiment, computer-implemented method 600 may include one or more processors configured for generating 608 mentorship match data based on the component attribute match scores, wherein the mentorship match data corresponds to a mentorship match between each pair of the plurality of user profiles.

In an embodiment, computer-implemented method 600 may include one or more processors configured for transforming the user profile data into model data corresponding to a representation of the profile attributes; generating a matching model based on the representation; and generating match data based on the matching model wherein the match data corresponds to an optimized mentorship match between each pair of the plurality of user profiles.

FIG. 7 depicts a block diagram of computing device 700 suitable for server 125 and/or computing device 120, in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

Computing device 700 includes communications fabric 702, which provides communications between cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

Programs may be stored in persistent storage 708 and in memory 706 for execution and/or access by one or more of the respective computer processors 704 via cache 716. In an embodiment, persistent storage 708 includes a magnetic hard disk drive. Alternatively, or in addition to a magnetic hard disk drive, persistent storage 708 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Programs, as described herein, may be downloaded to persistent storage 708 through communications unit 710.

I/O interface(s) 712 allows for input and output of data with other devices that may be connected to server 125 and/or computing device 120. For example, I/O interface 712 may provide a connection to external devices 718 such as image sensor, a keyboard, a keypad, a touch screen, and/or some other suitable input device. External devices 718 can also include portable computer readable storage media such as, for example, thumb drives, portable optical or magnetic disks, and memory cards. Software and data 714 used to practice embodiments of the present invention can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

Software and data 714 described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of computer-implemented methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method, comprising:
receiving, by one or more processors, user profile data corresponding to a plurality of user profiles each comprising profile attributes;
determining, by one or more processors, profile attribute match scores for each of the profile attributes between each pair of the plurality of user profiles based on respective profile attribute pairs; and
generating, by one or more processors, mentorship match data based on the profile attribute match scores, wherein the mentorship match data corresponds to a mentorship match between each pair of the plurality of user profiles.

2. The computer-implemented method of claim 1, wherein the user profile data further comprises feedback data selected from a group consisting of a prior mentorship match and a potential mentorship match between a pair of the plurality of user profiles.

3. The computer-implemented method of claim 2, further comprising:
transforming, by one or more processors, the user profile data into model data corresponding to a representation of the profile attributes;
generating, by one or more processors, a matching model based on the representation; and
generating, by one or more processors, match data based on the matching model wherein the match data corresponds to an optimized mentorship match between each pair of the plurality of user profiles.

4. The computer-implemented method of claim 1, further comprising:
determining, by one or more processors, a mentor match score for mentor user profiles having a mentor designation in the profile attributes in relation to mentee user profiles having a mentee designation in the profile attributes; and
determining, by one or more processors, a mentee match score for the mentee user profiles in relation to the mentor user profiles, wherein the profile attribute match scores include the mentor match score and the mentee match score.

5. The computer-implemented method of claim 1, further comprising:
receiving, by one or more processors, organizational objective data comprising profile attribute weights corresponding to a desired objective between the plurality of user profiles; and
applying, by one or more processors, the profile attribute weights to the profile attributes to generate weighted profile attributes.

6. The computer-implemented method of claim 5, wherein determining the profile attribute match scores is based on the weighted profile attributes, wherein the mentorship match data corresponds to a weighted optimized mentorship match between each pair of the plurality of user profiles comprising the weighted profile attributes.

7. The computer-implemented method of claim 1, wherein the profile attributes further comprise match requirement data corresponding to a profile attribute necessary to achieve a match between the plurality of user profiles.

8. The computer-implemented method of claim 7, further comprising:
assigning, by one or more processors, a do not match score to the profile attribute match score of each pair of the plurality of user profiles comprising the match requirement data that fails to satisfy a similarity threshold.

9. A computer program product, comprising:
one or more computer readable storage media and program instructions stored on the one or more computer readable storage media, the program instructions comprising:
program instructions to receive user profile data corresponding to a plurality of user profiles each comprising profile attributes;
program instructions to determine profile attribute match scores for each of the profile attributes between each pair of the plurality of user profiles based on respective profile attribute pairs; and
program instructions to generate mentorship match data based on the profile attribute match scores, wherein the mentorship match data corresponds to a mentorship match between each pair of the plurality of user profiles.

10. The computer program product of claim 9, wherein the user profile data further comprises feedback data selected from a group consisting of a prior mentorship match and a potential mentorship match between a pair of the plurality of user profiles.

11. The computer program product of claim 10, further comprising:
program instructions to transform the user profile data into model data corresponding to a representation of the profile attributes;
program instructions to generate a matching model based on the representation;
program instructions to generate match data based on the matching model wherein the match data corresponds to an optimized mentorship match between each pair of the plurality of user profiles.

12. The computer program product of claim 9, further comprising:
program instructions to determine a mentor match score for mentor user profiles having a mentor designation in the profile attributes in relation to mentee user profiles having a mentee designation in the profile attributes; and
program instructions to determine a mentee match score for the mentee user profiles in relation to the mentor user profiles, wherein the profile attribute match scores include the mentor match score and the mentee match score.

13. The computer program product of claim 9, further comprising:
program instructions to receive organizational objective data comprising profile attribute weights corresponding to a desired objective between the plurality of user profiles; and
program instructions to apply the profile attribute weights to the profile attributes to generate weighted profile attributes.

14. The computer program product of claim 13, wherein the program instructions to determine the profile attribute match scores is based on the weighted profile attributes, wherein the mentorship match data corresponds to a weighted optimized mentorship match between each pair of the plurality of user profiles comprising the weighted profile attributes.

15. The computer program product of claim 9, wherein the profile attributes further comprise match requirement data corresponding to a profile attribute necessary to achieve a match between the plurality of user profiles.

16. The computer program product of claim 15, further comprising:
program instructions to assign a do not match score to the profile attribute match score of each pair of the plurality of user profiles comprising the match requirement data that fails to satisfy a similarity threshold.

17. A computer system, comprising:
one or more computer processors;
one or more computer readable storage media;
program instructions stored on the one or more computer readable storage media for execution by at least one of the one or more processors, the program instructions comprising:
program instructions to receive user profile data corresponding to a plurality of user profiles each comprising profile attributes;
program instructions to determine profile attribute match scores for each of the profile attributes between each pair of the plurality of user profiles based on respective profile attribute pairs; and
program instructions to generate mentorship match data based on the profile attribute match scores, wherein the mentorship match data corresponds to a mentorship match between each pair of the plurality of user profiles.

18. The computer system of claim 17, wherein the user profile data further comprises feedback data selected from a group consisting of a prior mentorship match and a potential mentorship match between a pair of the plurality of user profiles.

19. The computer system of claim 18, further comprising:
program instructions to transform the user profile data into model data corresponding to a representation of the profile attributes;
program instructions to generate a matching model based on the representation;
program instructions to generate match data based on the matching model wherein the match data corresponds to an optimized mentorship match between each pair of the plurality of user profiles.

20. The computer system of claim 17, further comprising:
program instructions to determine a mentor match score for mentor user profiles having a mentor designation in the profile attributes in relation to mentee user profiles having a mentee designation in the profile attributes; and
program instructions to determine a mentee match score for the mentee user profiles in relation to the mentor user profiles, wherein the profile attribute match scores include the mentor match score and the mentee match score.

21. The computer system of claim 17, further comprising:
program instructions to receive organizational objective data comprising profile attribute weights corresponding to a desired objective between the plurality of user profiles; and
program instructions to apply the profile attribute weights to the profile attributes to generate weighted profile attributes.

22. The computer system of claim 21, wherein the program instructions to determine the profile attribute match scores is based on the weighted profile attributes, wherein the mentorship match data corresponds to a weighted optimized mentorship match between each pair of the plurality of user profiles comprising the weighted profile attributes.

23. The computer system of claim 17, wherein the profile attributes further comprise match requirement data corresponding to a profile attribute necessary to achieve a match between the plurality of user profiles.

24. The computer system of claim 23, further comprising:
program instructions to assign a do not match score to the profile attribute match score of each pair of the plurality of user profiles comprising the match requirement data that fails to exceed a similarity threshold.

25. The computer system of claim 17, further comprising:
program instructions to generate a graphical representation of the mentorship match between a pair of the plurality of user profiles having a greatest of the profile attribute match scores.
